(19) United States
(12) Patent Application Publication
(10) Pub. No.: US 2026/0163462 A1
(43) Pub. Date: Jun. 11, 2026

(54) ELECTRIC SEAT DRIVING DEVICE

(71) Applicant: AMOTECH CO., LTD., Incheon (KR)

(72) Inventor: Byung Soo KIM, Incheon (KR)

(21) Appl. No.: 18/716,686

(22) PCT Filed: Nov. 4, 2022
(86) PCT No.: PCT/KR2022/017244

§ 371 Date: Jun. 5, 2024

(30) Foreign Application Priority Data
Dec. 13, 2021 (KR) 10-2021-0177404

(51) Int. Cl. H02K 41/02; H02K 1/27; H02K 7/14

(52) U.S. Cl. CPC H02K 41/02; H02K 1/27; H02K 7/14

(57) ABSTRACT

Provided is an electric seat driving device for moving an electric seat linearly and reciprocally along a rod, including: a housing having both ends open, a case having a circular hollow portion, and first and second covers detachably coupled to both ends of the case; first and second bearings inside the first and second covers; a nut shaft where an outer circumference of one end is rotatably supported by the first bearing and an inner circumferential portion is axially coupled to the rod; a hollow rotor shaft whose one end is press-fitted and coupled to the outer circumference of the nut shaft and the other end is rotatably supported by the second bearing; a rotor where N-pole and S-pole magnets are alternately installed on the outer circumferential portion of the rotor shaft; and a stator embedded in the case and having a coil wound around the stator core.

### TECHNICAL FIELD

This invention relates to an electric seat driving device, especially an electric seat driving device that prevents slippage between a nut shaft and a rotor shaft and enhances coupling strength therebetween.

### BACKGROUND ART

In general, the seat of a vehicle has a backrest adjusted or its position changed by an electrical operation of a motor. Such a seat is referred to as an electric seat or a power seat, and a motor for driving such an electric seat or a power seat is referred to as an electric seat motor.

Slide rails are basically used to move the seat back and forth, and a lower rail of the slide rails is fixed to a floor inside the vehicle, and a cushion frame of the seat is fixed to an upper rail, allowing the seat to move in the front and rear direction together with the upper rail moving along the lower rail.

A power sliding device operates the upper rail by a motor, and recently, a type of motor installed inside the rail has been developed to simplify the configuration of the power sliding device and avoid interference with the surroundings during seat operation.

The motor is a hollow motor, a lead screw fixed to the lower rail is engaged with a nut of a rotor, and a motor case is fixed to the upper rail. When the motor is operated, the motor moves along a lead screw, and the upper rail to which the motor is fixed moves back and forth, so that the front and rear position of the seat may be adjusted. In addition, a brushless direct current (BLDC) motor was used as the hollow motor to reduce noise and vibration during operation.

Korean Laid-open Patent Publication No. 10-2019-0066898 (Patent Document 1) proposes a hollow BLDC motor of an automobile seat power sliding device that may further reduce noise and vibration generated when operating the power sliding device.

The hollow BLDC motor in Patent Document 1 has a structure in which it is difficult to efficiently utilize space because a nut coupled to a lead screw is placed at the center of a rotor sleeve. In addition, a skew-structured magnet is formed to reduce cogging torque, reducing noise and vibration of the motor, but assembly deteriorates as a rotor structure becomes more complex.

Korean Laid-open Patent Publication No. 10-2021-0114760 (Patent Document 2) proposes, considering that a rod that guides movement of an electric seat is installed close to a bottom of a vehicle's ride space, and thus, there is not enough space between the bottom of the vehicle's ride space and a bottom of a motor housing, a hollow BLDC motor in which a rotor shaft coupled to a rod (i.e., a lead screw) is set at a position eccentric downward from the center of the motor housing, and in response, and a stator uses a stator core with short teeth placed under a closed-loop-shaped yoke part and long teeth placed beyond a lower side of the yoke part.

The motor in Patent Document 2 employs a stator with an asymmetric structure in which a coil is wound only on the long teeth and a coil is not wound on the short teeth, while employing the stator core with an asymmetric structure. Accordingly, noise and vibration occur because sinusoidal back electromotive force (BEMF) is not obtained, and since it is not a structure in which a coil is wound around all teeth, the fill factor is low, making it difficult to maximize efficiency.

In addition, the rotor shaft of Patent Document 2 includes a first rotor shaft of which the inner circumferential portion is axially coupled to the rod and a second rotor shaft that is axially coupled to the outer circumference of the first rotor shaft and has a magnet installed on the outer circumference. Accordingly, as time elapses, an undesired rotation may be made between the first rotor shaft and the second rotor shaft in which a shaft coupling is performed. Therefore, this shaft coupling structure requires a separate structure to prevent rotation.

In this case, since the first rotor shaft axially coupled to the rod and the second rotor shaft equipped with the magnet include different materials depending on the use, a slip phenomenon may occur between the first rotor shaft and the second rotor shaft formed by a shaft coupling without a rotation prevention structure.

### DISCLOSURE

### Technical Problem

Therefore, this invention has been proposed to solve the problems of the above prior art, and an objective of this invention is to provide an electric seat driving device that enhances coupling strength between a nut shaft and a rotor shaft axially coupled to a rod while preventing slippage therebetween by coupling between the nut shaft and the rotor shaft by using a D-cut structure therebetween.

Another objective of this invention is to provide an electric seat driving device that may minimize generation of noise and vibration by employing a stator core of a symmetrical structure to obtain a sinusoidal back electromotive force (BEMF) and avoid a drop in the fill factor by winding a coil around all teeth of a symmetrical structure.

### Technical Solution

According to an aspect of this invention, there is provided an electric seat driving device for moving an electric seat back and forth along a rod, in a straight line, the electric seat driving device including: a housing having both ends open, a case having a circular hollow portion, and first and second covers detachably coupled to both ends of the case; first and second bearings provided inside the first and second covers; a hollow nut shaft in which an outer circumference of one end is rotatably supported by the first bearing and an inner circumferential portion is axially coupled to the rod; a hollow rotor shaft of which one end is press-fitted and coupled to the outer circumference of the nut shaft and the other end is rotatably supported by the second bearing; a rotor in which a plurality of N-pole and S-pole magnets are alternately installed on the outer circumferential portion of the rotor shaft; and a stator embedded in the case and having a coil wound around a stator core having a plurality of slot parts extended from an annular back yoke part with an air gap on the outside of the rotor, wherein the nut shaft and the rotor shaft form a rotary shaft of the rotor, and the press-fitted portion is coupled by a D-cut coupling to prevent slippage.

The rotor shaft is made of a carbon steel material for a mechanical structure to serve as a back yoke, and for example, the rotor shaft may be made of S45C.

The nut shaft may include first and second D-cut parts having a planar shape by cutting some of the left and right sides of a circular outer circumferential portion, and the rotor shaft may include a flat shape by adding ribs to the left and right sides of a circular inner circumferential portion, and include third and fourth D-cut parts which are surface-bonded to the first and second D-cut parts.

In this case, the nut shaft and the rotor shaft may be coupled by a D-cut coupling on one side of the circumferential portion.

The stator may include: a stator core which is embedded in the hollow portion of the case and in which a plurality of slot parts each having a T-shape are extended from an annular back yoke part with an air gap on the outside of the rotor; first and second insulating members having shapes corresponding to each other and coupled to insulate slot portions of the stator core from both sides thereof; and a coil wound around the first and second insulating members of the slot portions, wherein each of the first and second insulating members may include: an annular body; and a plurality of legs extending from the annular body in parallel with the axial direction and surrounding a shoe and teeth except for a front surface of the shoe facing the magnet of the rotor.

According to another aspect of the present invention, there is provided an electric seat driving device including: a housing having an electric seat seated on one side surface thereof and a hollow portion penetrating the inside thereof; first and second bearings provided inside both ends of the housing, respectively; a hollow rotary shaft of which both ends are rotatably supported by the first and second bearings and of which an inner circumferential portion of one side is axially coupled to a rod passing through the inner circumferential portion; a rotor in which a plurality of N-pole and S-pole magnets are alternately installed on an outer circumferential portion of the other side of the rotary shaft; and a stator embedded in the hollow portion of the housing to rotate the rotor by generating a rotating magnetic field while having an air gap on an outside of the rotor, wherein the rotary shaft includes: a hollow nut shaft in which an outer circumference of one end is rotatably supported by the first bearing and an inner circumferential portion is axially coupled to the rod; and a hollow rotor shaft of which one end is press-fitted to an outer circumference of the nut shaft and the other end is rotatably supported by the second bearing, in which a plurality of N-pole and S-pole magnets are alternately installed on the outer circumferential portion thereof, wherein portion press-fitted and coupled between the nut shaft and the rotor shaft is coupled by a D-cut coupling to at least one surface thereof.

In this case, the nut shaft may be made of synthetic resin, and the rotor shaft may be made of carbon steel for mechanical structure so as to also function as a back yoke.

### Advantageous Effects

As described above, in this invention, by coupling between a nut shaft and a rotor shaft axially coupled to a rod, by using a D-cut structure, it is possible to enhance the coupling strength between the nut shaft and the rotor shaft while preventing slippage between the nut shaft and the rotor shaft.

In addition, a motor of a driving device of this invention may minimize generation of noise and vibration by employing a stator core of a symmetrical structure to obtain a sinusoidal back electromotive force (BEMF) and avoid a drop in the fill factor by winding a coil around all teeth of a symmetrical structure.

### BRIEF DESCRIPTION OF THE DRAWINGS

FIG. 1A is a perspective view illustrating an electric seat driving device according to an embodiment of the present invention, and FIG. 1B is a use state diagram in which the electric seat driving device is coupled to a lead screw.

FIG. 2A is an exploded perspective view illustrating a housing and a motor separated from each other in an electric seat driving device, and FIG. 2B is an exploded perspective view of the motor.

FIG. 3 is a longitudinal cross-sectional view taken along line A-A in FIG. 1.

FIG. 4 is a longitudinal cross-sectional view taken along line B-B in FIG. 1.

FIG. 5 is a cross-sectional view in which only a motor part is separated from FIG. 4.

FIGS. 6 and 7 are cross-sectional views taken along lines C-C and D-D of FIG. 3, respectively.

### BEST MODE FOR CARRYING OUT THE INVENTION

Hereinafter, embodiments of the present invention will be described in detail with reference to the accompanying drawings.

The sizes and shapes of the components shown in the drawings may be exaggerated for clarity and convenience. In addition, terms defined in consideration of the configuration and operation of the present invention may vary depending on the intention or custom of the user, the operator, and the like. Definitions of these terms should be based on the content of this specification.

An electric seat driving device according to the present invention may be used when moving an electric seat of a vehicle back and forth.

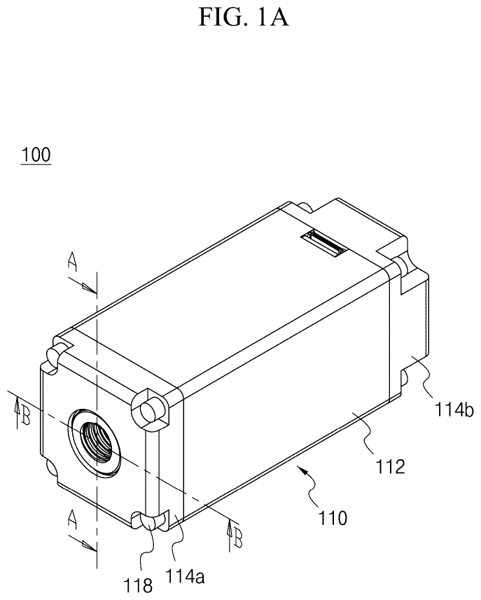

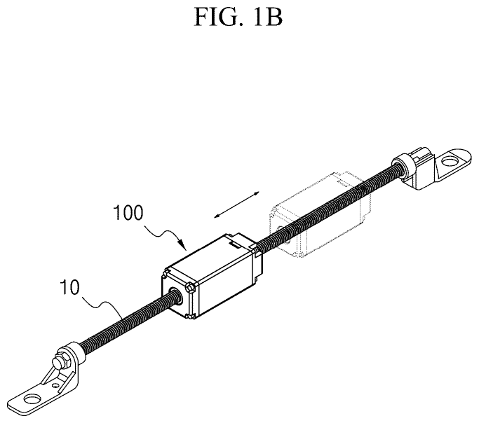

First, referring to FIGS. 1A and 1B, an electric seat driving device 100 according to an embodiment of the present invention serves as a driving source capable of linearly reciprocating an electric seat of a vehicle, which is an object, along a rod 10 having a predetermined length.

For example, the electric seat driving device 100 according to an embodiment of this invention may be installed on the side of the rod 10 with a predetermined length as shown in FIG. 1B, and may reciprocate in a longitudinal direction of the rod 10 through relative movement when power is applied.

Here, the rod 10 may be a known lead screw installed on the bottom surface of a vehicle's ride space to install an electric seat in the vehicle's ride space, and the object may be an electric seat.

That is, the electric seat may be fixed to one side surface of the electric seat driving device 100 according to an embodiment of the present invention, and the electric seat may reciprocate in the longitudinal direction of the lead screw through the movement of the electric seat driving device 100 reciprocating along the lead screw when the electric seat driving device 100 is driven.

However, the electric seat driving device 100 according to an embodiment of this invention may be used as a driving source for reciprocating objects other than the electric seat in the longitudinal direction of the rod 10 having a predetermined length.

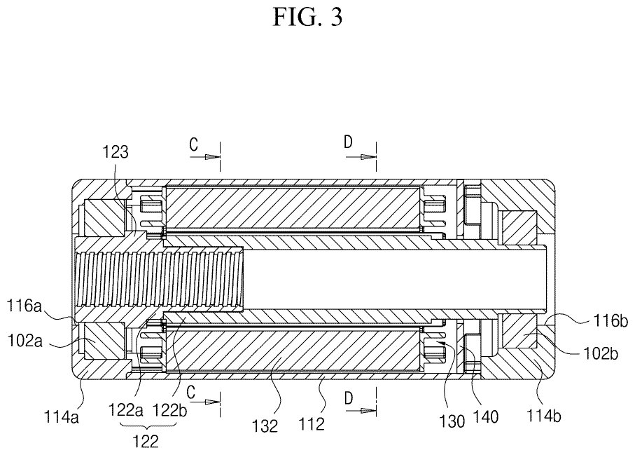

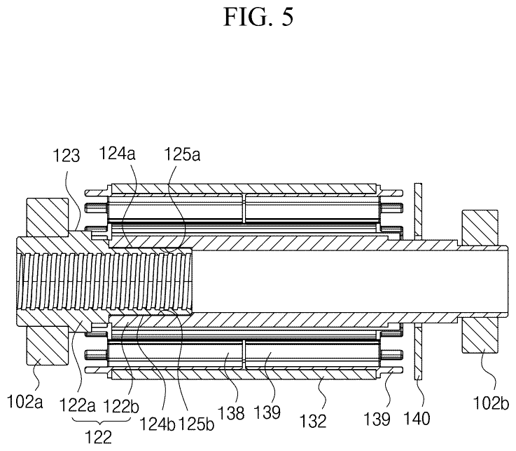

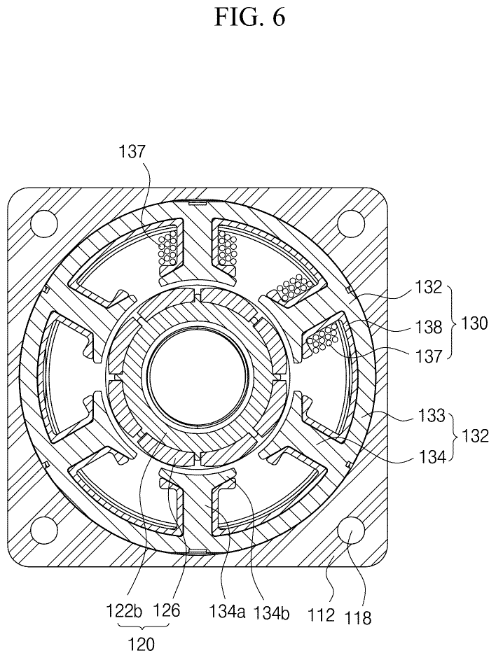

As described above, the electric seat driving device 100 according to an embodiment of the present invention includes a housing 110, a rotor 120, and a stator 130, as shown in FIGS. 1A to 7.

The housing 110 may accommodate the rotor 120 and the stator 130 therein, and the electric seat may be coupled to an upper side thereof.

The housing 110 includes a hollow structure so that the rod 10 may be inserted into the housing 110 and coupled to the rotor 120.

The housing 110 may include the rotor 120 forming an inner rotor type motor 150 with both ends open, a case 112 accommodating the stator 130 therein, and a pair of covers 114a and 114b detachably coupled to both ends of the case 112 via fastening members 118.

The housing 110 may preferably have a quadrangular cylindrical outer shape, and an electric seat may be installed on an upper surface thereof.

The case 112 of the housing 110 has a circular hollow portion to accommodate the circular stator 130 therein, and the pair of covers 114a and 114b have through holes 116a and 116b formed in the center so that the rod 10 may be inserted therein.

In addition, a printed circuit board (PCB) 140 for controlling the driving of the rotor 120 and the stator 130 may be embedded inside the housing 110, for example, at the rear end of the case 112.

The PCB 140 is equipped with various circuit components for motor driving circuits that control the driving device, in which a coil 137 of the stator 130 is electrically connected to the motor driving circuits, and a Hall sensor (not shown) that generates a rotational position signal of the rotor 30.

Moreover, the pair of first and second covers 114a and 114b coupled to both ends of the case 112 serve as bearing housings, respectively, and accommodate a pair of first and second bearings 102a and 102b inside, respectively. Both ends of the rotor 120 nay be rotatably mounted by means of the pair of first and second bearings 102a and 102b provided inside the pair of first and second covers 114a and 114b, respectively.

The rotor 120 may be axially coupled to the rod 10 passing through the housing 110 through openings 116a and 116b, and the housing 110 may move along the rod 10 when the rotor 120 rotates.

Accordingly, in the electric seat driving device 100 according to an embodiment of the present invention, as the rotation of the housing 110 is suppressed when the rotor 120 rotates, the housing 110 may reciprocate linearly along the rod 10.

To this end, the rotor 120 may include a hollow rotary shaft 122 that is axially coupled to the rod 10 and reciprocates linearly along the rod 10 when rotating, and a plurality of magnets 126 installed along an outer circumferential surface of the rotary shaft 122.

When current is supplied to the coil 137 wound around the stator 130, the rotor 120 may be rotated through interaction with the rotating magnetic field generated from the coil 137.

In the electric seat driving device 100 according to an embodiment of the present invention, the rotary shaft 122 is located in the center of the housing 110, and by minimizing the length axially coupled to the rod 10, it is possible to reduce power consumption and noise generation for driving by reducing friction.

To this end, the rotary shaft 122 may include a hollow nut shaft 122a that is axially coupled to the rod 10 and reciprocates linearly along the rod 10 when rotating, and a hollow rotor shaft 122b that is coupled to the nut shaft 122a by a D-cut coupling and having a magnet 126 installed so that a plurality of N poles and S poles are alternately arranged along the outer circumferential surface.

In this case, the above nut shaft 122a includes synthetic resin, and the rotor shaft 122b may use S45C, which is a carbon steel material for mechanical structures, as a metal material that may have the strength necessary for the role of the rotary shaft while serving as a back yoke. That is, the rotor shaft 122b may use, for example, heavy carbon steel having a carbon content of 0.45 % in Fe to perform the role of both the back yoke and the rotary shaft.

In this case, the rod 10 may be axially coupled to the nut shaft 122a, but may simply pass through the inside of the rotor shaft 122b. As a non-limiting example, the nut shaft 122a may be a known lead screw nut with a female thread formed on the inner circumferential portion thereof, and the rod 10 may be a known lead screw with a male thread formed on the outer circumferential portion thereof.

Accordingly, when the nut shaft 122a is rotated, the nut shaft 122a may be moved forward and backward through screw movement along the thread of the lead screw, and only a part of the total length of the rotary shaft 122 is axially coupled to the rod 10, thereby reducing friction and reducing power consumption for driving.

In this invention, a shaft coupling method of the rod 10 with the rotary shaft 122 has been illustrated as a screw coupling method, but the present invention is not limited thereto, and various known shaft coupling methods may be applied as long as the shaft may be coupled and reciprocate in the longitudinal direction of the rod 10 through rotation.

The nut shaft 122a has a thread formed on the inner circumferential portion for shaft coupling with the rod 10, and a stopper ring 123 that acts as a stopper to limit the inner position of the first bearing 102a embedded in the first cover 114a protrudes in an annular shape on the outer circumferential portion.

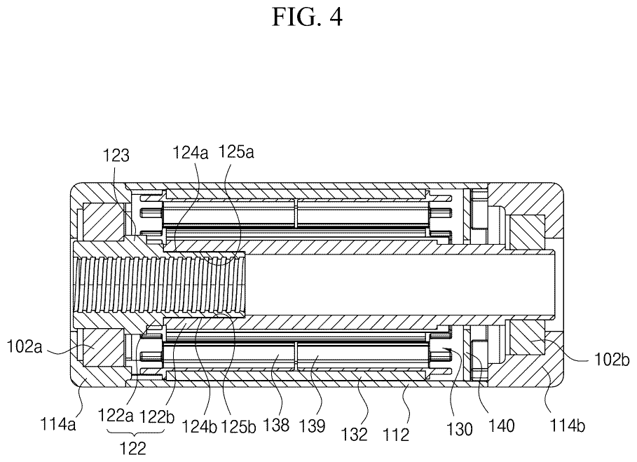

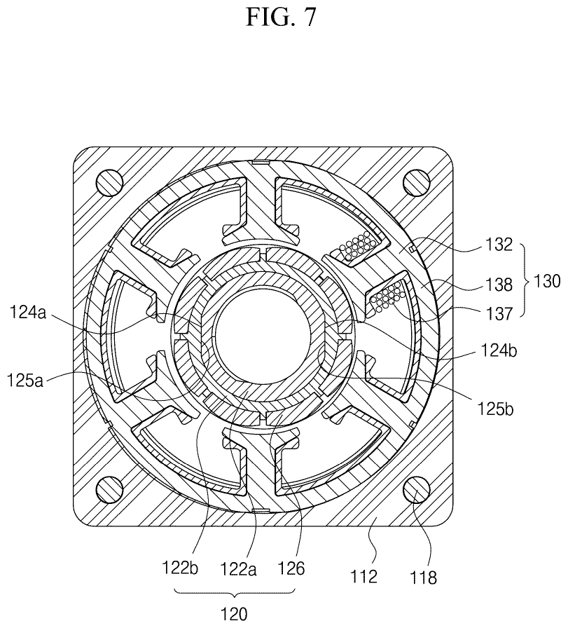

In addition, as shown in FIGS. 4 and 7, when combined with the rotor shaft 122b, first and second D-cut parts 124a and 124b each having a flat shape are respectively formed on the left and right sides of the inner outer circumferential portion of the stopper ring 123 on the nut shaft 122a by cutting a part of the circular outer circumferential portion, and in response thereto, third and fourth D-cut parts 125a and 125b each having a flat shape by adding ribs to the circular inner circumferential portion in a similar manner and being surface-bonded to the first and second D-cut parts are respectively formed on the left and right sides of the inner circumferential portion of the rotor shaft 122b.

Accordingly, when the nut shaft 122a and the rotor shaft 122b are coupled to each other, the first and second D-cut parts 124a and 124b and the third and fourth D-cut parts 125a and 125b may be assembled in a press-fitting manner so as to coincide with each other.

In this invention, in order to enhance coupling strength between the two shafts, when a pair of D-cut structural coupling is performed on both side surfaces facing between the nut shaft 122a and the rotor shaft 122b, it is possible to increase the coupling strength between the two shafts while preventing slippage that may occur during screw coupling. The D-cut structural coupling is a simplest and inexpensive shaft coupling structure capable of preventing slippage between two shafts.

In the embodiment, in order to maximize the coupling strength between the two shafts, a pair of D-cut structural coupling structures are designed to be performed on both side surfaces facing between the nut shaft 122a and the rotor shaft 122b, but it is also possible to combine a D-cut structural coupling on one side of the circumferential surface thereof.

The stator 130 may be arranged to surround the magnet 126 of the rotor 120.

That is, the stator 130 may be fixed inside the housing 110 to surround the circumference of the rotor 120, and may provide a rotating magnetic field as a driving force for rotating the rotor 120 at the time of an application of power.

To this end, the stator 130 may include a stator core 132 fixed to the inside of the housing 110 and a coil 137 wound around the stator core 132.

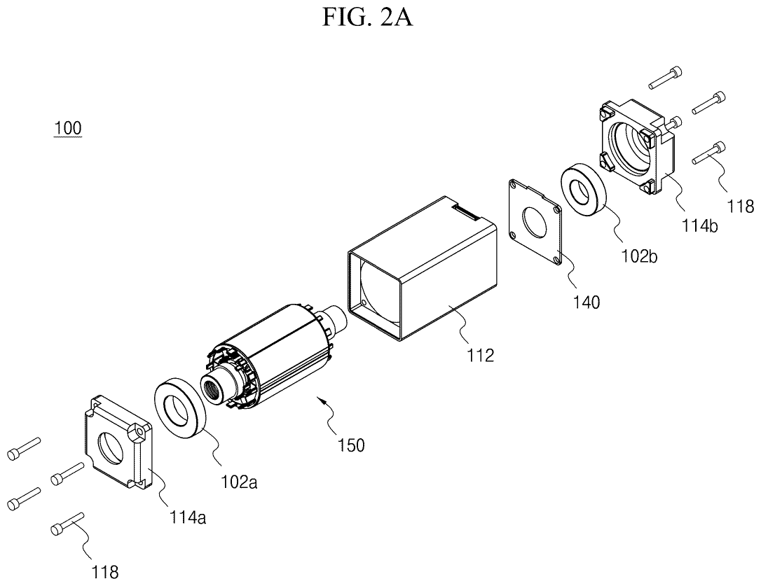

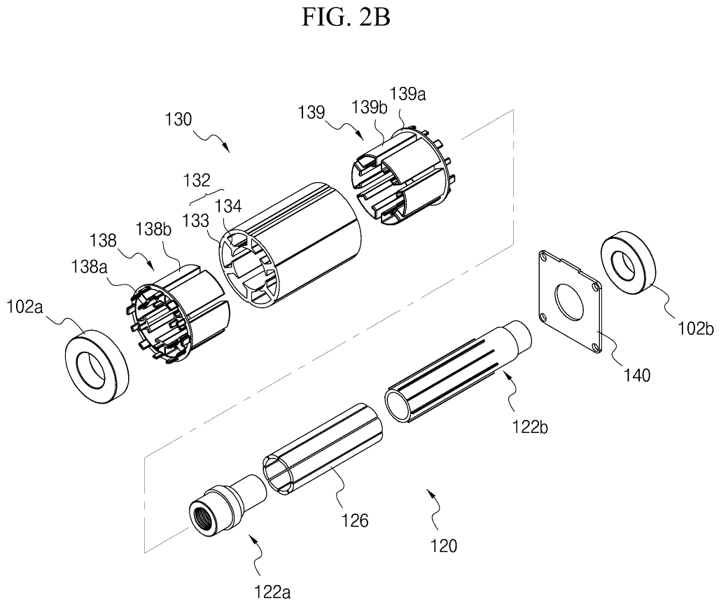

Specifically, as shown in FIGS. 2B, 6 and 7, the stator core 132 may include an annular back yoke part 133 fixed to the inside of the housing 110 and a plurality of slot parts 134 extending from the back yoke part 133 toward the rotor 120, and each of the slot parts 134 may include a tooth 134a extending at a predetermined length from the back yoke part 133 and a shoe 134b formed at the end of the tooth 134a.

Here, the back yoke part 133 may be formed to have a circular shape, and the plurality of slot parts 134 may be formed on the back yoke part 133 to form a virtual circle when connecting the ends of the respective shoes 134b arranged to face the rotor 120.

Each of the plurality of slot parts 134 has a T-shape, and air gaps are formed at equal intervals between the magnets 126 of the rotor 120.

In the stator 130, the stator core 132 including the back yoke part 133 and the plurality of slot parts 134 is formed by blanking thin film electrical steel seats S-60 and then stacking the blanked thin film electrical steel seats at a constant thickness.

In addition, a first insulating member 138 and a second insulating member 139 are inserted between the stator core 132 and the coil 137 of the stator 130 for insulation.

Each of the first insulating member 138 and the second insulating member 139 has a shape corresponding to each other, as shown in FIG. 2B, and includes a plurality of legs 138b and 139b surrounding the shoe 134b and the tooth 133a, except for the front surface of the shoe 134b, which extends parallel to the axial direction from the body and faces the magnet 126 of the rotor 120.

The first insulating member 138 and the second insulating member 139 may be coupled to each other from both directions of the stator core 132 to insulate the stator core 132.

Meanwhile, the electric seat driving device 100 according to an embodiment of the present invention may be implemented as a single-phase motor or a three-phase motor. In the case of a three-phase motor, when the number of magnets 126 provided in the rotor 120 is 8, the three-phase motor may be implemented in an 8-pole/6-slot structure.

The electric seat driving device 100 according to an embodiment of the present invention illustrates a 3:4 structure in which the total number of slot parts 134 is six and the total number of magnets 126 is eight. However, the present invention is not limited thereto, and the ratio of the total number of magnets to the total number of slot parts may be variously changed in a structure of any one of 3:2, 9:8, 9:10, and 1:1 and may be implemented as a three-phase or single-phase motor.

Although the embodiment illustrates that the magnet of the rotor is formed in the form of a plurality of split pieces, the magnet may be configured as an integrated magnet having a structure in which the N pole and the S pole are alternately split and magnetized.

In addition, the embodiment suggests a structure in which the first insulating member 138 and the second insulating member 139 prepared in advance to insulate between the stator core 132 and the coil 137 of the stator 130 are assembled from both sides to the stator core 132. However, a thermosetting resin, for example, a bulk molding compound (BMC) molding material such as polyester, or a thermoplastic resin is molded on the outer circumferential portion of the stator core 132 to form a stator support integrally thereon. In this case, a bobbin defining a region in which a coil is wound may be integrally formed at the shoe of the stator core except for a portion facing the magnet of the rotor.

In addition, in the case of the stator, the bobbin and the stator support are integrally formed in the stator core and three-phase (U, V, and W) coils 137 are wound on the teeth.

As described above, in this invention, by coupling between the nut shaft 122a and the rotor shaft 122b axially coupled to the rod 10, by using a D-cut structure, it is possible to enhance the coupling strength between the nut shaft and the rotor shaft while preventing slippage between the nut shaft and the rotor shaft.

In addition, in this invention, as the motor of the driving device 100 adopts a stator core 132 with a symmetrical structure, a sinusoidal back electromotive force (BEMF) is obtained to minimize generation of noise and vibration, and By winding the coil 137 around all teeth 134 having a symmetrical structure arranged at equal angles from the annular back yoke part 133, a decrease in the fill factor may be avoided.

While the present invention has been particularly shown and described with reference to exemplary embodiments thereof, by way of illustration and example only, it is clearly understood that the present invention is not to be construed as limiting the present invention, and various changes and modifications may be made by those skilled in the art within the protective scope of the invention without departing off the spirit of the present invention.

### INDUSTRIAL APPLICABILITY

The present invention may be used in an electric seat driving device that increases coupling strength between a nut shaft and a rotor shaft while preventing a slip phenomenon between the nut shaft and the rotor shaft.

What is claimed is:

1. An electric seat driving device for moving an electric seat back and forth along a rod in a straight line, the electric seat driving device comprising:
a housing having both ends open, a case having a circular hollow portion, and first and second covers detachably coupled to both ends of the case;
first and second bearings provided inside the first and second covers;
a hollow nut shaft in which an outer circumference of one end is rotatably supported by the first bearing and an inner circumferential portion is axially coupled to the rod;
a hollow rotor shaft of which one end is press-fitted and coupled to the outer circumference of the nut shaft and the other end is rotatably supported by the second bearing;
a rotor in which a plurality of N-pole and S-pole magnets are alternately installed on the outer circumferential portion of the rotor shaft; and
a stator embedded in the case and having a coil wound around a stator core having a plurality of slot parts extended from an annular back yoke part with an air gap on the outside of the rotor, wherein
the nut shaft and the rotor shaft form a rotary shaft of the rotor, and the press-fitted portion is coupled by a D-cut coupling to prevent slippage.

2. The electric seat driving device of claim 1, wherein the rotor shaft comprises a carbon steel material for a mechanical structure to serve as a back yoke.

3. The electric seat driving device of claim 2, wherein the rotor shaft comprises S45C.

4. The electric seat driving device of claim 1, wherein the nut shaft comprises first and second D-cut parts having a planar shape by cutting some of the left and right sides of a circular outer circumferential portion, and the rotor shaft comprises a flat shape by adding ribs to the left and right sides of a circular inner circumferential portion, and include third and fourth D-cut parts which are surface-joined to the first and second D-cut parts.

5. The electric seat driving device of claim 1, wherein the nut shaft and the rotor shaft are coupled by a D-cut coupling on one side of a circumferential portion thereof.

6. The electric seat driving device of claim 1, wherein the stator comprises:
a stator core which is embedded in the hollow portion of the case and in which a plurality of slot parts each having a T-shape are extended from an annular back yoke part with an air gap on the outside of the rotor;
first and second insulating members having shapes corresponding to each other and coupled to insulate slot portions of the stator core from both sides thereof; and
a coil wound around the first and second insulating members of the slot portions, wherein
each of the first and second insulating members comprises: an annular body; and a plurality of legs extending from the annular body in parallel with the axial direction and surrounding a shoe and teeth except for a front surface of the shoe facing the magnet of the rotor.

7. An electric seat driving device comprising:
a housing having an electric seat seated on an upper surface thereof and a hollow portion penetrating the inside thereof;
first and second bearings provided inside both ends of the housing, respectively;
a hollow rotary shaft of which both ends are rotatably supported by the first and second bearings and of which an inner circumferential portion of one side is axially coupled to a rod passing through the inner circumferential portion;
a rotor in which a plurality of N-pole and S-pole magnets are alternately installed on an outer circumferential portion of the other side of the rotary shaft; and
a stator embedded in the hollow portion of the housing to rotate the rotor by generating a rotating magnetic field while having an air gap on an outside of the rotor, wherein
the rotary shaft comprises: a hollow nut shaft in which an outer circumference of one end is rotatably supported by the first bearing and an inner circumferential portion is axially coupled to the rod; and
a hollow rotor shaft of which one end is press-fitted to an outer circumference of the nut shaft and the other end is rotatably supported by the second bearing, in which a plurality of N-pole and S-pole magnets are alternately installed on the outer circumferential portion thereof, wherein a portion press-fitted and coupled between the nut shaft and the rotor shaft is coupled by a D-cut coupling to at least one surface thereof.

8. The electric seat driving device of claim 7, wherein the nut shaft comprises synthetic resin, and the rotor shaft comprises carbon steel for mechanical structure so as to also function as a back yoke.
